(19) United States
(12) Patent Application Publication
(10) Pub. No.: US 2026/0179827 A1
(43) Pub. Date: Jun. 25, 2026

(54) COIL DEVICE, PULSE TRANSFORMER, ELECTRONIC COMPONENT, AND METHOD OF MANUFACTURING ELECTRONIC COMPONENT

(71) Applicant: TDK CORPORATION, Tokyo (JP)

(72) Inventors: Ryoei SHINOHARA, Tokyo (JP); Kouyu OHI, Yurihonjo-city (JP)

(73) Assignee: TDK CORPORATION, Tokyo (JP)

(21) Appl. No.: 19/410,558

(22) Filed: Dec. 5, 2025

(30) Foreign Application Priority Data
Dec. 19, 2024 (JP) 2024-224189

(51) Int. Cl. H01F 27/28; H01F 27/29; H01F 38/14

(52) U.S. Cl. CPC H01F 27/2828; H01F 27/29; H01F 38/14; H01F 2038/143

(57) ABSTRACT

An electronic component includes a wire and a terminal electrode connected to a lead of the wire and at least partly covered with a deposited film. The deposited film of the terminal electrode connected to the lead includes a surface having a glossy surface with fewer surface irregularities than those of a non-glossy surface remaining as-is as of formation of the deposited film. The glossy surface is located near the lead connected to the terminal electrode.

### TECHNICAL FIELD

The present invention relates to a coil device used as a pulse transformer or the like, an electronic component, and a method of manufacturing the electronic component.

### BACKGROUND

Known as a coil device used as a pulse transformer or the like is a coil device disclosed in, for example, Patent Document 1. In such a conventional coil device, a lead portion of a wire forming a coil may be connected to a terminal electrode including a mounting surface using thermocompression bonding.

However, in the conventional coil device, a film covering the wire may partly remain, as a film residue, on the mounting surface of the terminal electrode at the time of thermocompression bonding. This may generate a void or the like in a connecting member (e.g., solder) that connects the mounting surface of the terminal electrode and a substrate when the coil device is mounted on the substrate. From the void, a crack may be generated, which may reduce connection reliability.

To solve such inconvenience, it is suggested that the film residue should be removed using laser irradiation, as shown in Patent Document 2 below. This conventional technique removes the film residue, significantly improving bonding strength and improving bonding reliability from those of a conventional structure in which solder bonding is performed in the presence of the film residue.

However, this conventional technique is mainly intended for removal of the film residue and uses high laser beam output. This may leave a laser irradiation mark in stripes on an easy bonding layer (e.g., a Sn film) on the surface of the terminal electrode, possibly partly scraping the easy bonding layer off. This is common among, besides the coil device, other electronic components including a terminal electrode connected to a lead of a wire.
Patent Document 1: JP Patent Application Laid Open No. 2018-78155
Patent Document 2: JP Patent Application Laid Open No. 2020-61421

### SUMMARY

The present invention has been achieved in view of such circumstances. It is an object of the invention to provide a coil device, a pulse transformer, and an electronic component with further improvable bonding strength and high thermal shock resistance and a method of manufacturing the electronic component.

To achieve the above object, an electronic component according to one aspect of the present invention is
an electronic component including
a wire; and
a terminal electrode connected to a lead of the wire and at least partly covered with a deposited film,
wherein
the deposited film of the terminal electrode connected to the lead includes a surface having a glossy surface with fewer surface irregularities than those of a non-glossy surface remaining as-is as of formation of the deposited film, and
the glossy surface is located near the lead connected to the terminal electrode.

In this electronic component, the glossy surface is provided on the surface of the deposited film on a surface of the terminal electrode connected to the lead of the wire. The glossy surface is provided on the surface of the deposited film (e.g., a Sn plating film as an easy bonding layer) on the surface of the terminal electrode and makes it easy to join with a connecting member (e.g., solder).

The wire may be covered with an insulating film. At the time of, for example, thermocompression bonding of the lead of the wire with the insulating film to the surface of the terminal electrode, a film residue may adhere to the surface of the terminal electrode near the lead. Irradiating the surface of the terminal electrode near the lead with an energy ray (e.g., a laser) to remove the film residue forms the glossy surface on the surface of the irradiated deposited film. It is assumed that the glossy surface is formed through an increase in sizes of constituent grains of the deposited film in a planar direction by heat energy based on a relatively low-output energy ray (e.g., a UV laser).

According to this electronic component, the surface of the deposited film near the lead connected to the terminal electrode using thermocompression bonding or the like is provided with the glossy surface and has the film residue or the like removed. Thus, at the time when the surface (mounting surface) of the terminal electrode connected to the lead is connected to a land of a substrate or the like using the connecting member (e.g., solder), the connecting member is less prone to have a void or the like. This prevents generation of a crack, enhancing connection reliability.

The surface of the deposited film near the lead connected to the terminal electrode using thermocompression bonding or the like is provided with the glossy surface. The deposited film is not provided with grooves in stripes formed with a high-output laser (e.g., a carbon dioxide laser). The deposited film with the glossy surface continues in the planar direction. This further enhances strength of bonding with solder for mounting and bonding reliability, enhancing thermal shock resistance.

Preferably, the glossy surface is provided on the surface of the terminal electrode for a predetermined distance along a longitudinal direction of the lead connected to the terminal electrode. More preferably, the glossy surface is provided for a longer range than the entire length of connection between the lead and the terminal electrode along the longitudinal direction. That is, the glossy surface is preferably provided for a range to which foreign matter (e.g., the film residue formed at the time of thermocompression bonding) adheres and from which the foreign matter can be removed.

Preferably, the glossy surface is provided on the surface of the terminal electrode for at least a predetermined width from a centerline of the lead to both sides of the centerline. More preferably, the glossy surface is provided for a range that is not smaller than a predetermined width along which foreign matter (e.g., the film residue formed at the time of thermocompression bonding) adheres and is capable of having the foreign matter removed.

The terminal electrode may include a connecting portion connected to the lead and an extending portion extending from the connecting portion. The connecting portion and the extending portion may continuously have the glossy surface. The connecting portion may have the glossy surface, and the extending portion may have the non-glossy surface.

The extending portion may be bent at a predetermined angle relative to the connecting portion. The connecting portion may become the mounting surface that faces, for example, the land of the substrate. The extending portion, which is bent at the predetermined angle relative to the connecting portion, may be a portion where a fillet of the connecting member (e.g., solder) is formable. Formation of the non-glossy surface of the deposited film on the surface of the extending portion, where the fillet is formable, provides the surface with fine irregularities. This makes it easier to form the fillet of the connecting member (e.g., solder) in a relatively large area. It is assumed that capillary action through spaces between the fine irregularities or the like makes molten solder or the like easier to spread.

An electronic component according to another aspect of the present invention further includes a core including a wound portion and a flange,
the wire is wound around the wound portion,
the extending portion of the terminal electrode is partly attached to a part of an outer surface of the core, and
the connecting portion is at least partly away by a predetermined distance from the outer surface of the core.

This electronic component is specifically a coil device. At least a part of the connecting portion of the terminal electrode with the glossy surface is away from the outer surface of the core. This can improve coplanarity (flatness) of the mounting surface of the coil device. This also improves resistance to distortion, vibration, or the like of a substrate caused when the coil device is mounted on the substrate or the like, enabling enhancement of mounting reliability.

A coil device according to another aspect of the present invention is
a coil device including
a wire; and
a terminal electrode connected to a lead of the wire and at least partly covered with a deposited film,
wherein
the deposited film of the terminal electrode connected to the lead includes a surface having a glossy surface with fewer surface irregularities than those of a non-glossy surface remaining as-is as of formation of the deposited film, and
the glossy surface is located near the lead connected to the terminal electrode.

Because the deposited film of the terminal electrode connected to the lead includes the surface having the glossy surface with fewer surface irregularities than those of the non-glossy surface remaining as-is as of formation of the deposited film, this coil device exhibits effects similar to those of the electronic component described above.

Uses of the above coil device are not limited. The coil device can be used as, for example, a pulse transformer.

A method of manufacturing an electronic component, according to one aspect of the present invention includes
thermocompression bonding a lead of a wire to a surface of a terminal electrode; and irradiating the surface near the lead bonded to the terminal electrode with an energy ray to smooth a surface of a deposited film on the surface of the terminal electrode for formation of a glossy surface near the lead.

In this method of manufacturing an electronic component, irradiation of the energy ray (e.g., a laser) can remove foreign matter (e.g., a film residue formed through thermocompression bonding of the lead of the wire with an insulating film to the surface of the terminal electrode). At the same time, on the surface of the deposited film irradiated with the energy ray, a glossy surface is formed. It is assumed that the glossy surface is formed through an increase in sizes of constituent grains of the deposited film in the planar direction by heat energy based on a relatively low-output energy ray (e.g., a UV laser).

### BRIEF DESCRIPTION OF THE DRAWING(S)

FIG. 1 is a perspective view of a coil device according to one embodiment of the present invention.

FIG. 2 is an exploded view of the coil device shown in FIG. 1.

FIG. 3 is a partial enlarged perspective view of joints between terminal electrodes and leads of the coil device shown in FIG. 1.

FIG. 4 is a plan view of one terminal electrode shown in FIG. 3 viewed from above along the Z-axis.

FIG. 4A is a plan view, corresponding to FIG. 4, of a state immediately after thermocompression bonding of a lead of a wire to the terminal electrode.

FIG. 5 is a main sectional view of the terminal electrode with the lead and a core cut along a line V-V shown in FIG. 4.

FIG. 6 is a main sectional view of the terminal electrode with the lead and the core cut along a line VI-VI shown in FIG. 4.

FIG. 7 is a main sectional view of the coil device soldered onto a substrate.

FIG. 8A is a graph showing results of measurement of a deposited film surface (glossy surface) of the terminal electrode after laser irradiation.

FIG. 8B is a graph showing results of measurement of irregularities of a deposited film surface (non-glossy surface) of the terminal electrode before laser irradiation.

### DETAILED DESCRIPTION

Hereinafter, an embodiment is described.

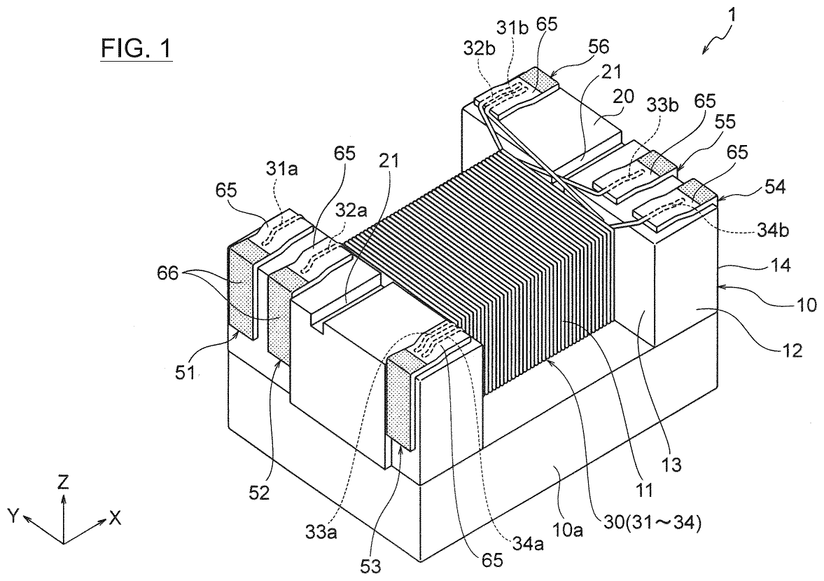

As shown in FIG. 1, a coil device 1 is a surface-mounting coil component used as, for example, a pulse transformer. The coil device 1 includes a drum core 10 as a drum-shaped core member, a coil 30, and terminal electrodes 51 to 56.

An upper surface of the coil device 1 along the Z-axis direction in FIG. 1 becomes a mounting surface of the coil device 1 when it is mounted on a substrate or the like. In the following description, an axis parallel to a winding axis of the coil 30 of the coil device 1 is defined as the X-axis; an axis parallel to the height direction of the coil device 1 is defined as the Z-axis; and an axis substantially perpendicular to the X-axis and the Z-axis is defined as the Y-axis.

The coil device 1 may have any external dimensions. The coil device 1 has, for example, a length of 2.0 to 6.0 mm along the X-axis, a width of 1.0 to 6.0 mm along the Y-axis, and a height of 1.0 to 4.0 mm along the Z-axis.

The drum core 10 includes a wound portion 11 (a rod-like portion located inside the coil 30 in FIG. 1) around which the coil 30 is wound and flanges 12 and 12 in pairs at both ends of the wound portion 11 in the X-axis direction. The wound portion 11 has a substantially rectangular sectional shape in the present embodiment but may have any other sectional shapes, such as a polygonal shape, a circular shape, or an oval shape. The two flanges 12 and 12 have the same substantially rectangular parallelepiped external shape as shown in FIG. 1 but may have different shapes or sizes.

The drum core 10 is composed of a magnetic body and contains, for example, a magnetic material with relatively high permeability (e.g., Ni—Zn based ferrites and Mn—Zn based ferrites) or a magnetic powder (e.g., a metal magnetic body).

The two flanges 12 and 12 are disposed substantially parallel to each other with a predetermined space therebetween in the X-axis direction. Both ends of the wound portion 11 in the X-axis direction are connected to central portions, in the Y-axis direction, of facing inner surfaces 13 and 13 of the flanges 12 and 12 in pairs. It may be that there are no grooves 21; however, the presence of the grooves 21 on the mounting surface side can improve insulation between the terminal electrodes 52 (55) and 53 (56).

A mounting-side surface 20 of one flange 12 is provided with three terminal electrodes, which are the first to third terminal electrodes 51 to 53. A mounting-side surface 20 of the other flange 12 is provided with three terminal electrodes, which are the fourth to sixth terminal electrodes 54 to 56.

The wound portion 11 of the drum core 10 is provided with the coil 30. In the present embodiment, the coil 30 is composed of four wires 31 to 34 wound around the wound portion 11. The first wire 31 and the second wire 32 constitute primary coils of a pulse transformer. The third wire 33 and the fourth wire 34 constitute secondary coils. The first wire 31 and the second wire 32, which constitute the primary coils, are wound in opposite directions. The third wire 33 and the fourth wire 34, which constitute the secondary coils, are wound in opposite directions.

Ends (leads) 31a to 34a and 31b to 34b of the four wires 31 to 34 wound in such a manner are connected to the terminal electrodes 51 to 56 disposed on the flanges 12 and 12 of the drum core 10 using thermocompression bonding, respectively.

Specifically, one end 31a of the first wire 31 is connected to the first terminal electrode 51. One end 32a of the second wire 32 is connected to the second terminal electrode 52. One end 33a of the third wire 33 and one end 34a of the fourth wire 34 are connected to the third terminal electrode 53.

The other end 31b of the first wire 31 and the other end 32b of the second wire 32 are connected to the sixth terminal electrode 56. The other end 33b of the third wire 33 is connected to the fifth terminal electrode 55. The other end 34b of the fourth wire 34 is connected to the fourth terminal electrode 54.

With the wires 31 to 34 wound and connected to the terminal electrodes 51 to 56 in such a structure, the first terminal electrode 51 and the second terminal electrode 52 are primary coil-side terminal electrodes (input-side terminal electrodes), and the fourth terminal electrode 54 and the fifth terminal electrode 55 are secondary coil-side terminal electrodes (output-side terminal electrodes). The third terminal electrode 53 and the sixth terminal electrode 56 are center taps of the primary coil side (input side) and the secondary coil side (output side), respectively.

Each of the wires 31 to 34 is composed of a conductive wire with a film. For example, a core material composed of a good conductor (e.g., copper (Cu)) is covered with an insulating material composed of imide-modified polyurethane or the like and is further covered with a thin resin film composed of polyester or the like at an outermost surface. However, core materials or film materials of the wires 31 to 34 are not limited to these materials.

The wire diameters, the numbers of turns, winding methods, the numbers of layers of the wires of the coil 30, or the like of the wires 31 to 34 may be determined for each wire according to required properties of the coil device 1. In the present embodiment, the wires 31 to 34 have the same wire diameter and the same number of turns. The wires 31 and 33 (or the wires 32 and 34) are wound in the same direction per pair. In the coil 30, the four wires are wound in, for example, two layers.

Each of the terminal electrodes 51 to 56 is integrally formed using bending of a metal sheet-like terminal electrode member. The terminal electrode member is composed of, for example, metal (e.g., copper and copper alloys) or other conductive plate.

In the present embodiment, the terminal electrodes 51 to 56 have the same size and the same shape and each include a connecting portion 65 and an extending portion 66. However, the connecting portions 65 of the terminal electrodes 53 and 56, to which the ends of two wires are connected, may have a larger width in the Y-axis direction than that of the connecting portions 65 of the other terminal electrodes 51, 52, 54, and 55.

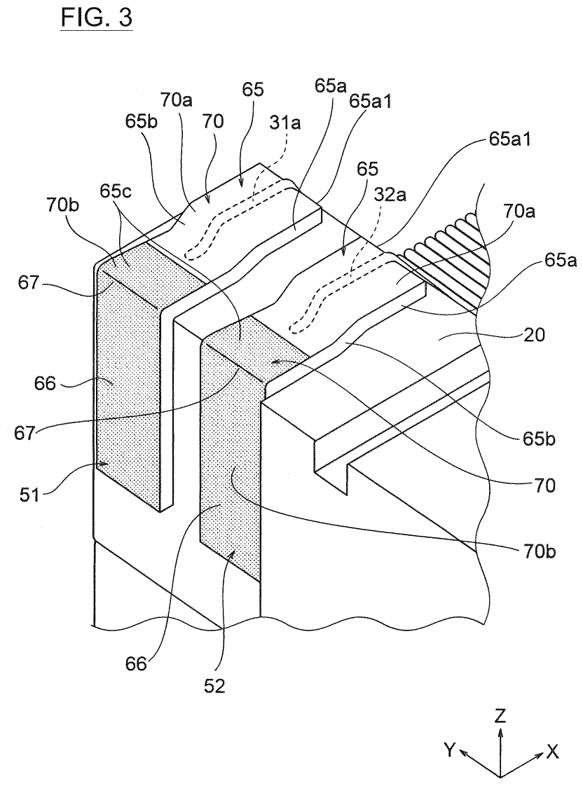

In the present embodiment, as shown in, for example, FIG. 3, the extending portion 66 is continuously provided at one side of the connecting portion 65 in the X-axis direction so as to be bent downward along the Z-axis from a boundary 67 between the extending portion 66 and the connecting portion 65. An end 65a, which is at least a part of the connecting portion 65, is coupled, at a step portion 65b, to a base portion 65c, which is another part of the connecting portion, or to the extending portion 66. The end 65a is at a predetermined distance from the mounting-side surface 20, which is one of outer surfaces of the core. Note that, in the present embodiment, the step portion 65b is not necessarily provided. For example, the connecting portion 65 in its entirety, which is bent from the extending portion 66 fixed to the flange of the core, may be lifted from the mounting-side surface 20 by a predetermined distance without the presence of the step portion 65b.

It is preferred that, in such a manner, at least a part (e.g., the end 65a) of the connecting portion 65 of the terminal electrode is freely movable relative to the mounting-side surface 20, which is the upper surface of the flange 12 in the Z-axis direction, without being adhered thereto. Not fixing the at least a part (e.g., the end 65a) of the connecting portion 65 to the mounting-side surface 20 of the flange 12 using adhesion can improve coplanarity (flatness) of the mounting surface of the coil device 1. This also improves resistance to distortion, vibration, or the like of a substrate caused when the coil device 1 is mounted on the substrate or the like, enabling enhancement of mounting reliability.

In the present embodiment, the connecting portion 65 is disposed above the mounting-side surface 20 and has at least one of the ends 31a to 34a and 31b to 34b of the wires 31 to 34 thermocompression bonded in subsequent steps. For this reason, although the connecting portion 65 may adhere tightly to the mounting-side surface 20, it is more preferred to provide a space between them. The presence of the space between the connecting portion 65 and the mounting-side surface 20 increases the range of elastic deformation of the connecting portion 65, possibly further enhancing thermal shock resistance or the like after the coil device 1 is mounted on a substrate or the like. The presence of the space can also further improve coplanarity (flatness) of the mounting surface of the coil device 1.

As shown in FIG. 3, each of the ends 31a and 32a of the wires (the same applies to the ends 33a to 34a and 31b to 34b of the wires shown in FIG. 1 hereinafter) is thermocompression bonded to the connecting portion 65 for a predetermined distance from an extremity 65a1 of the connecting portion 65 to the boundary 67 between the extending portion 66 and the connecting portion 65 or to somewhere close to the boundary 67. In the present embodiment, each of the ends 31a and 32a of the wires is thermocompression bonded to the connecting portion 65 from the extremity 65a1 of the connecting portion 65 to somewhere close to the step portion 65b, somewhere partway through the step portion 65b, or somewhere past the step portion 65b (close to the boundary 67).

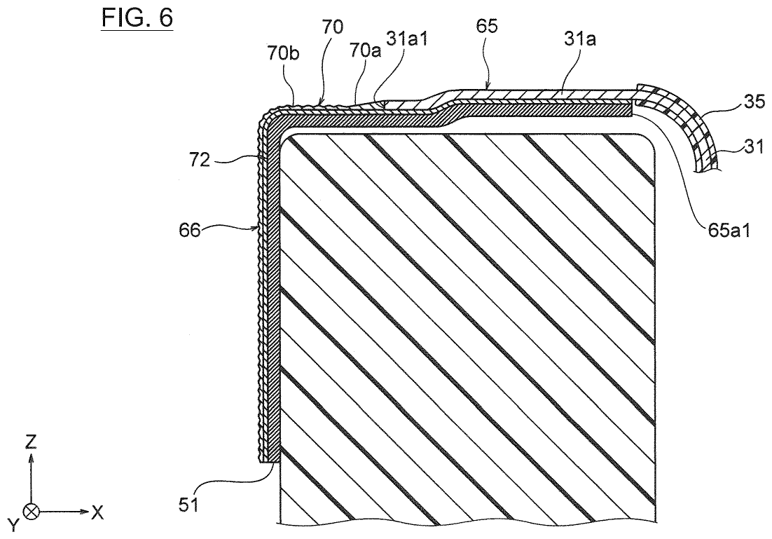

In the present embodiment, as shown in, for example, FIG. 6, at least an outer surface of the terminal electrode 51 (the same applies to the terminal electrodes 52 to 56 hereinafter) is provided with an easy bonding layer 70. Between the easy bonding layer 70 and the terminal electrode 51 may be an intermediate layer 72. The easy bonding layer 70 and the intermediate layer 72 are each a deposited film including a single layer or multiple layers formed using a plating method or the like on the outer surface of the terminal electrode 51 (also possible on its inner surface). In the present embodiment, the easy bonding layer 70 is composed of Sn or a Sn alloy, and the intermediate layer is composed of Ni, a Ni alloy, Ag, a Ag alloy, Cu, a Cu alloy, or the like.

In the present embodiment, the wire 31 with conductivity (the same applies to the wires 32 to 34 hereinafter) is covered with an insulating film 35; however, at the wire's end 31a thermocompression bonded to the terminal electrode 51, the insulating film 35 is removed at the time of thermocompression bonding. The end 31a, having the insulating film 35 removed by pressure and heat of thermocompression bonding, of the wire 31 with conductivity tightly adheres to and is connected to a surface of the easy bonding layer 70 or a surface of the intermediate layer 72 at least partly pushed aside by pressure and heat of thermocompression bonding, from the extremity 65a1 of the terminal electrode 51 to an extremity 31a1 of the end 31a of the wire. Although omitted in the drawings, the end 31a of the wire 31 has a shape squashed along the Z-axis by pressure and heat of thermocompression bonding.

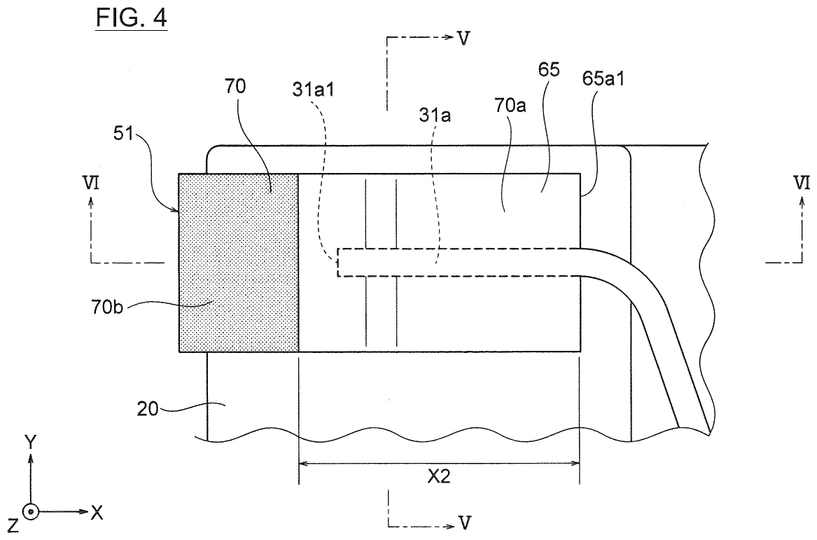

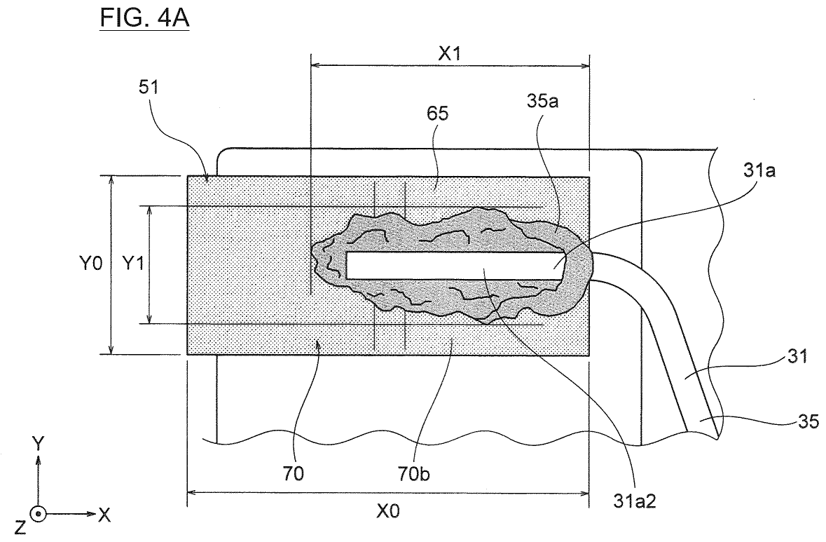

As shown in FIG. 4, near the easy bonding layer 70 (which may hereinafter be referred to as Sn film 70) near the end 31a (which may hereinafter be referred to as lead 31a) of the wire connected to the terminal electrode 51 is a glossy surface 70a. The glossy surface 70a is a surface with fewer surface irregularities than those of a non-glossy surface 70b, which is a deposited surface as of formation of the Sn film 70 using the plating method. The glossy surface 70a is a surface with glossiness in appearance.

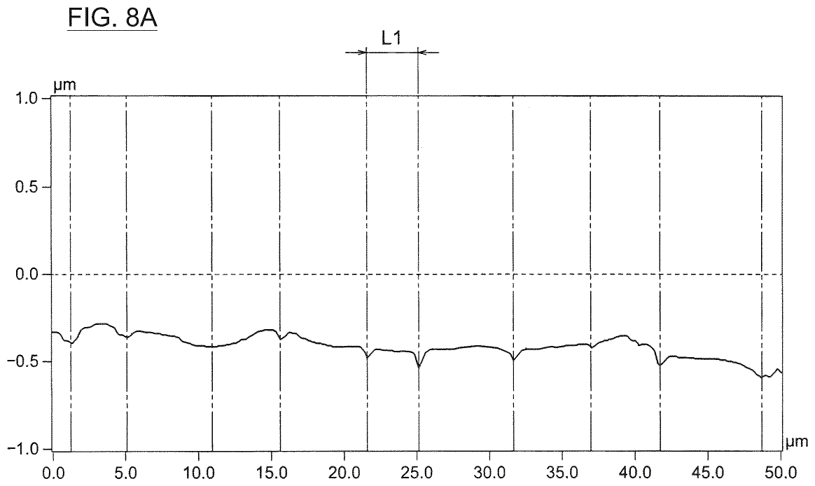

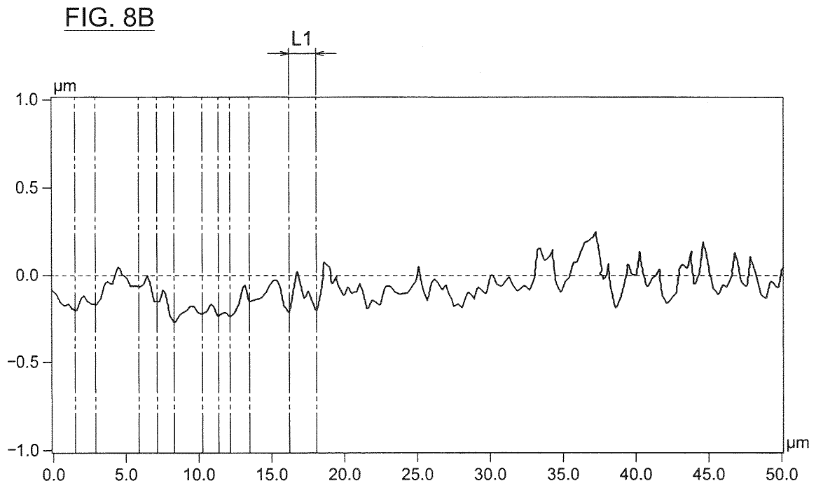

As shown in FIG. 8A, the glossy surface 70a is smooth with fewer irregularities along a distance (horizontal axis) in a planar direction of the glossy surface 70a compared to the surface roughness of the non-glossy surface 70b shown in FIG. 8B. The glossy surface 70a appears to be a surface with glossiness in appearance. As shown in FIG. 8B, the non-glossy surface 70b has many surface irregularities and appears to be a surface without glossiness in appearance due to scattering of light or the like.

Methods of quantifying a difference in surface states between the glossy surface 70a, which has been irradiated with a laser, and the non-glossy surface 70b, which is an unprocessed deposited surface that has not yet been irradiated with a laser, are not limited. Examples of such methods may include the following method. As shown in FIG. 8A or FIG. 8B, for example, a laser scanning method or an apparatus such as a laser microscope is used to measure the surface state of the surface 70a or 70b.

In that situation, the difference in the surface states can be represented using the number of valleys (local minimum points) with at least a predetermined depth between hills (local maximum points) with at least a predetermined height in a curve showing the surface roughness relative to a length of the surface in one direction. Alternatively, the difference in the surface states can be represented using a distance between adjacent valleys (local minimum points). Note that a valley with a depth smaller than the predetermined depth (e.g., smaller than 0.01 μm) from close hills in pairs and those hills are not taken into account.

As shown in FIG. 8A, as for the glossy surface 70a, the number of valleys (local minimum points) with at least the predetermined depth is represented by the number of dashed-and-double-dotted vertical lines and is fifteen or less in a straight line distance of 50 μm along the planar direction. Also, the distance L1 between adjacent valleys (local minimum points) averages 3 μm or more.

As shown in FIG. 8B, as for the non-glossy surface 70b, the number of valleys (local minimum points) with at least the predetermined depth is represented by the number of dashed-and-double-dotted vertical lines and is thirty or more in a straight line distance of 50 μm along the planar direction. Also, the distance L1 between adjacent valleys (local minimum points) averages less than 3 μm.

Through sectional observation of the Sn film 70 with the glossy surface 70a and the Sn film 70 with the non-glossy surface 70b using an electron microscope, it has been possible to confirm that the sizes of constituent grains of the glossy surface 70a are at least twice the sizes of constituent grains of the non-glossy surface 70b in the planar direction.

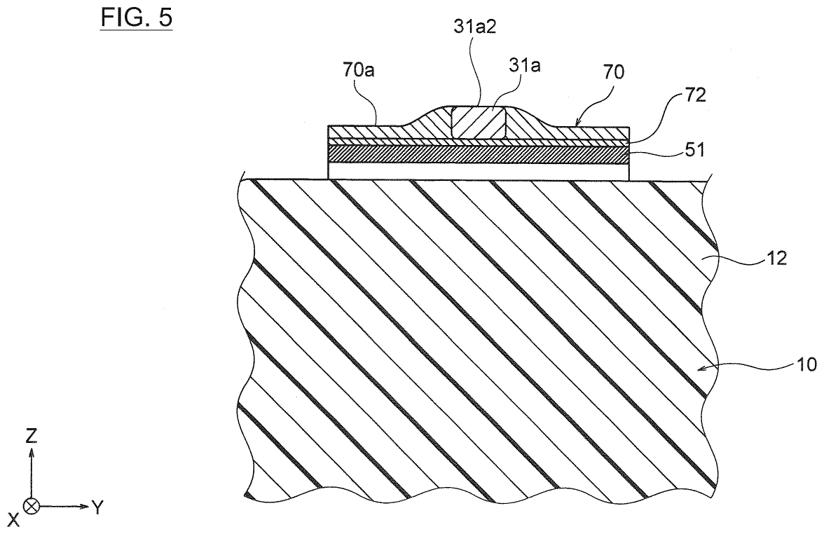

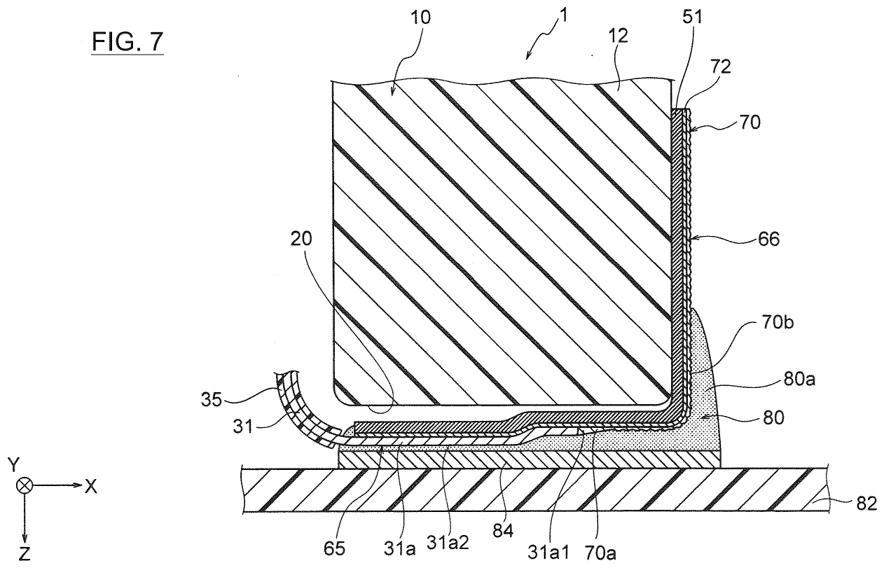

In the present embodiment, as shown in FIG. 5, an exposed surface 31a2 of the lead 31a along the Z-axis is preferably connected to and exposed from this glossy surface 70a of the Sn film 70 so as to be flush therewith. This is because the exposed surface 31a2 of the lead 31a and the glossy surface 70a provide a mounting surface connectable to a land 84 of a substrate 82 or the like using a connecting member 80 (e.g., solder) as shown in, for example, FIG. 7.

The Sn film 70 with the glossy surface 70a has a thickness that is approximately equivalent to or is not more than that of the Sn film 70 with the non-glossy surface 70b. The thickness of the Sn film 70 with the glossy surface 70a is preferably 1.0 to 2.0 μm. Thermocompression bonding may make the thickness of the Sn film with the glossy surface 70a thinner than the thickness of the Sn film with the non-glossy surface. However, it is confirmed that laser irradiation does not change the thickness.

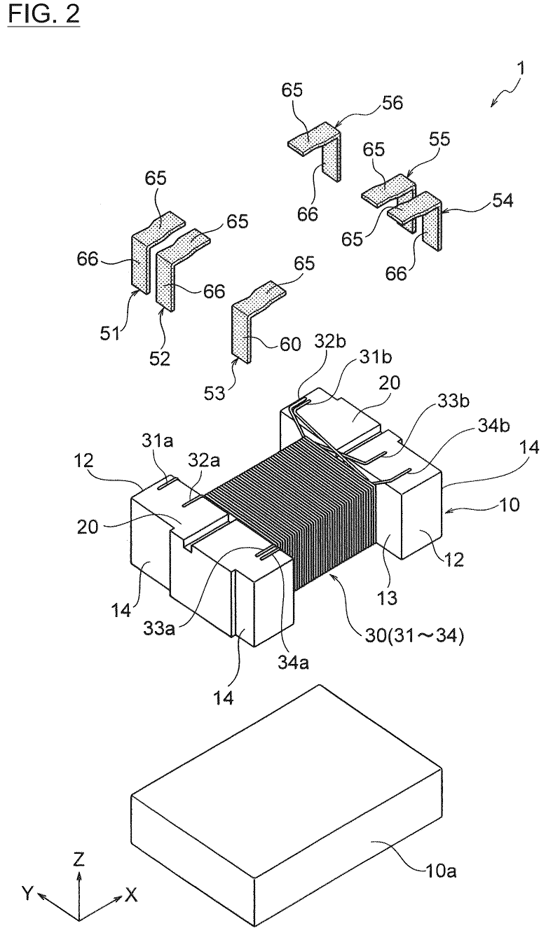

A manufacturing method is described next. First, the terminal electrodes 51 to 56 are placed on the drum core 10 shown in FIG. 2. Although the wires 31 to 34 are wound around the drum core 10 in FIG. 2, preferred in practice is placing the terminal electrodes 51 to 56 on the drum core 10 before the wires 31 to 34 are wound around the drum core 10.

To place the terminal electrodes 51 to 56, the connecting portions 65 of the terminal electrode members are disposed on the mounting-side surfaces 20, and the extending portions 66 are adhered to outer surfaces 14 and 14 of the flanges 12 and 12 using an adhesive.

Methods of providing the terminal electrodes 51 to 56 are not limited to the method of placing the terminal electrode members. The terminal electrodes 51 to 56 may be provided through a baking treatment of a printed or an applied conductive film, plating treatment, or the like.

After the terminal electrodes 51 to 53 and 54 to 56 are attached to the flanges of the drum core 10, the drum core 10 is set to a winding machine to wind the wires 31 to 34 around the wound portion 11 of the drum core 10 in a predetermined order.

At the time of winding, the ends 31a to 34a and 31b to 34b of the wires 31 to 34 are fixed to the corresponding connecting portions 65 of the terminal electrodes 51 to 56 using thermocompression bonding. For example, with regard to connection of the end 32a of the second wire 32 to the connecting portion 65 of the second terminal electrode 52, while a part of the wire 32 pulled by the winding machine (not shown in the drawings) is disposed on the connecting portion 65 of the second terminal electrode 52, the wire 32 and the connecting portion 65 are heated from above using a heater (not shown in the drawings) for pressure welding.

Thermocompression bonding melts or removes the insulating film 35 of the wire 32, exposes the core material (conductor) of the wire 32, and bonds the wire 32 to the connecting portion 65 of the terminal electrode 52 for electrical connection.

With regard to the flanges 12 and 12, on which three terminal electrodes 51 to 53 and 54 to 56 are disposed respectively, one wide-width heater may be used for either flange 12 for thermocompression bonding, or a single heater may be used at different locations for thermocompression bonding of the four wires 31 to 34.

The one wide-width heater can also be used to simultaneously thermocompression bond the ends of the wires 32 and 34, which are wound in the same direction. Thus, for the coil device 1, it is possible to make a step of thermocompression bonding the ends 31a to 34a and 31b to 34b of the wires 31 to 34 to the terminal electrodes 51 to 56 easier and to simplify a manufacturing apparatus.

After thermocompression bonding of the ends 31a to 34a and 31b to 34b of the wires 31 to 34 to the terminal electrodes 51 to 56 is completed, unwanted portions of the ends 31a to 34a and 31b to 34b of the wires are cut off. The unwanted portions are portions distal to the connecting portions. For example, with regard to the first wire 31 bonded to the first terminal electrode 51, an unwanted portion distal to the bonded portion (end 31a) of the wire 31 is cut off using a wire cutter lowered from above (not shown in the drawings) for removal.

After thermocompression bonding of the ends 31a to 34a and 31b to 34b of the wires 31 to 34 to the terminal electrodes 51 to 56 and cutting of the unwanted portions are completed, a surface treatment using a laser is performed to the terminal electrodes 51 to 56.

As shown in, for example, FIG. 4A, on a surface of the first terminal electrode 51 to which the end (lead) 31a of the first wire 31 is connected, there remains a film residue 35a of insulating resin (e.g., polyurethane) used as the insulating film of the wire 31.

At the portion where the film residue 35a remains, a surface of the easy bonding layer 70 at an outermost surface of the terminal electrode 51 is not exposed. Before laser irradiation, the surface of the easy bonding layer 70 is the non-glossy surface 70b, similarly to the film surface immediately after deposition of the Sn film 70. At the connecting portion 65 of the first terminal electrode 51, the exposed surface 31a2 (conductive surface) of the lead 31a of the wire 31 is exposed by thermocompression bonding. The exposed surface 31a2 is where, as described earlier, the insulating film 35 of the wire 31 is melted or removed to expose the core material (Cu in the present embodiment), which is a conductor, of the wire 31.

The surface of the connecting portion 65 of the terminal electrode 51 shown in FIG. 4A is irradiated with a laser beam as an energy ray to remove the film residue 35a, preferably for an area larger than the area defined by a length X1 of the film residue 35a along the X-axis and a width Y1 of the film residue 35a along the Y-axis. At this time, irradiation conditions (e.g., laser type or intensity (wavelength, peak intensity, pulse width, or the like)) are not limited provided that the film residue 35a can be removed and that the surface of the easy bonding layer 70 as the deposited film at the outermost surface of the terminal electrode 51 can become the glossy surface.

Using a UV laser or the like, which is a relatively low-output energy ray, a predetermined range of the surface of the connecting portion 65 of the terminal electrode 51 is irradiated with a laser beam once or multiple times. In the surface treatment using the laser, the laser beam may be scanned at predetermined pitches along the longitudinal direction (X-axis direction) of the lead 31a of the wire 31.

More specifically, irradiation using a laser beam with a pulse frequency of 20 kHz to 60 kHz at a scanning speed of 100 mm/sec or more and less than 2000 mm/sec for one to three times can remove the film residue 35a and form the glossy surface 70a. It is assumed that the glossy surface 70a is formed through melting of the component of the Sn film 70 using heat of the laser beam and solidification of the component.

As the surface treatment using the laser beam is performed to predetermined ranges of the surfaces of the connecting portions 65 of the terminal electrodes 51 to 56, the film residue is mostly scattered away, and the glossy surface 70a is formed on the surfaces of the terminal electrodes, as shown in, for example, FIGS. 3 and 4 showing the first terminal electrode 51 to which the first wire 31 is connected. The range where the glossy surface 70a is formed is preferably larger than the range where the film residue 35a is provided in FIG. 4A.

A length X2 of the glossy surface 70a along the X-axis is, for example, preferably larger than the length X1 of the film residue 35a along the X-axis and preferably not larger than a length X0 of the connecting portion 65 along the X-axis. A width of the glossy surface 70a along the Y-axis is preferably larger than the width Y1 of the film residue 35a along the Y-axis and preferably not larger than a width Y0 of the connecting portion 65 along the Y-axis.

In the coil device 1 of the present embodiment, the glossy surface 70a is provided on the surface of the terminal electrode 51 (the same applies to the terminal electrodes 52 to 56 unless otherwise specified) connected to the lead 31a (the same applies to the leads 32a to 34a and 31b to 34b unless otherwise specified) of the wire 31 (the same applies to the wires 32 to 34 unless otherwise specified), as shown in FIGS. 3 and 4. The glossy surface 70a is provided on the surface of the deposited film (e.g., easy bonding layer 70) on the surface of the terminal electrode 51 and makes it easy to join with the connecting member (e.g., solder).

As shown in FIG. 6, the wire 31 is covered with the insulating film 35. At the time of thermocompression bonding of the lead 31a of the wire 31 to the surface of the terminal electrode 51, the film residue 35a may adhere to the surface of the terminal electrode 51 near the lead 31a as shown in FIG. 4A. Irradiating the surface of the terminal electrode 51 near the lead 31a with an energy ray (e.g., a laser) to remove the film residue 35a forms the glossy surface 70a on the surface of the irradiated easy bonding layer 70 as shown in FIG. 4. It is assumed that the glossy surface 70a is formed through an increase in sizes of the constituent grains of the easy magnetization layer 70 in the planar direction by heat energy based on a relatively low-output energy ray (e.g., a UV laser).

According to this coil device 1, the surface of the easy bonding layer 70 near the lead 31a connected to the terminal electrode 51 using thermocompression bonding or the like is provided with the glossy surface 70a and has the film residue 35a or the like removed. Thus, at the time when the surface (mounting surface) of the terminal electrode 51 connected to the lead 31a is connected to the land 84 of the substrate 82 or the like using the connecting member 80 (e.g., solder) as shown in FIG. 7, the connecting member 80 is less prone to have a void or the like. This prevents generation of a crack, enhancing thermal shock resistance and connection reliability. In the present embodiment, it is confirmed that, for example, no crack is generated in a 1500-cycle thermal shock test (test condition: −40°C to 125° C.).

The surface of the deposited film near the lead connected to the terminal electrode 51 using thermocompression bonding or the like is provided with the glossy surface. The deposited film is not provided with grooves in stripes formed with a high-output laser (e.g., a carbon dioxide laser). The easy bonding layer 70 as the deposited film with the glossy surface 70a continues in the planar direction. This further enhances strength of bonding with the connecting member 80 for mounting and bonding reliability, enhancing thermal shock resistance.

In the present embodiment, the glossy surface 70a is provided on the surface of the terminal electrode 51 for the predetermined distance along the longitudinal direction (substantially parallel to the X-axis direction) of the lead 31a connected to the terminal electrode 51. More preferably, the glossy surface 70a is provided for a longer range than the entire length of connection between the lead 31a and the terminal electrode 51 along the longitudinal direction. That is, the glossy surface 70a is provided for a range of laser irradiation capable of removing foreign matter (e.g., the film residue 35a formed at the time of thermocompression bonding).

As shown in, for example, FIG. 7, in the present embodiment, because the extending portion 66 is bent at a predetermined angle relative to the connecting portion 65, the connecting portion 65 becomes the mounting surface that faces, for example, the land 84 of the substrate 82. The extending portion 66, which is bent at the predetermined angle relative to the connecting portion 65, is a portion where a fillet 80a of the connecting member 80 (e.g., solder) is formable. Formation of the non-glossy surface 70b of the deposited film 70 on the surface of the extending portion 66, where the fillet 80a is formable, provides the surface with fine irregularities. This makes it easier to form the fillet 80a of the connecting member 80 (e.g., solder) in a relatively large area. It is assumed that capillary action through spaces between the fine irregularities or the like makes molten solder or the like easier to spread.

Moreover, in the present embodiment, at least a part of the connecting portion 65 of the terminal electrode with the glossy surface 70a shown in FIG. 4 is away from the mounting-side surface 20 of the flange 12 (outer surface of the core 10) as shown in, for example, FIG. 7. This can improve coplanarity (flatness) of the mounting surface of the coil device 1. This also improves resistance to distortion, vibration, or the like of the substrate 82 caused when the coil device 1 is mounted on the substrate 82 or the like, enabling enhancement of mounting reliability.

In the manufacturing method according to the present embodiment, irradiation of an energy ray (e.g., a laser) can remove foreign matter (e.g., the film residue 35a formed through thermocompression bonding of the leads 31a to 34b of the wires 31 to 34 with the insulating film to the surfaces of the terminal electrodes 51 to 56). At the same time, on the surface of the easy bonding layer 70, i.e., the deposited film irradiated with the energy ray, the glossy surface 70a is formed. It is assumed that the glossy surface 70a is formed through an increase in sizes of the constituent grains of the deposited film in the planar direction by heat energy based on a relatively low-output energy ray (e.g., a UV laser).

The present invention is not limited to the above embodiment and can be variously modified within the scope of the present invention.

In the above embodiment, as shown in FIG. 1, to surfaces opposite the mounting-side surfaces 20 of the flanges 12 and 12 in pairs, a plate-like core 10a magnetically connecting these flanges 12 and 12 is joined using adhesion or the like; however, there may not necessarily be the plate-like core 10a.

In the above embodiment, the third terminal electrode 53 and the sixth terminal electrode 56 are provided as the center taps of the input side and the output side, respectively; however, the center taps may be omitted according to uses. In that situation, the third terminal electrode 53 and the sixth terminal electrode 56 become unnecessary, and it becomes possible to provide a coil device (pulse transformer) with two wires.

Moreover, in the above embodiment, the terminal electrodes 51 to 56 are attached to the flanges 12 as metal sheet members separate from the drum core 10; however, the terminal electrodes 51 to 56 may be directly formed on the outer surfaces of the flanges using methods such as baking of an electrode paste, plating, or vapor deposition. It is confirmed that baked electrodes formed using an electrode paste can also be provided with a similar glossy surface 70a.

In the above embodiment, the present invention is described as a device suitable as a pulse transformer for transmission of pulse signals via a LAN cable or the like; however, uses of the present invention are not limited to this use. The present invention is applicable to other coil devices, such as common mode filters, and is applicable to all electronic components in which a lead of a wire is connected to a terminal electrode using thermocompression bonding or methods other than thermocompression bonding.

Moreover, in the above embodiment, the extending portions 66 of the terminal electrodes 51 to 56 are bent at the predetermined angle relative to the connecting portions 65; however, depending on the structure of a coil device or an electronic component, the extending portions 66 and the connecting portions 65 may be disposed on the same plane.

### REFERENCE NUMERALS

1 . . . coil device
10 . . . drum core
10a . . . plate-like core
11 . . . wound portion
12 . . . flange
13 . . . inner surface
14 . . . outer surface
20 . . . mounting-side surface
21 . . . groove
30 . . . coil
31 to 34 . . . wire
31a to 34a, 31b to 34b . . . end (lead)
31a1 . . . extremity
31a2 . . . exposed surface
35 . . . insulating film
35a . . . film residue
51 to 56 . . . terminal electrode
65 . . . connecting portion
65a . . . end (part of connecting portion)
65a1 . . . extremity
65b . . . step portion
65c . . . base portion (another part of connecting portion)
66 . . . extending portion
67 . . . boundary
70 . . . easy bonding layer/easy magnetization layer (Sn film/deposited film)
70a . . . glossy surface
70b . . . non-glossy surface
72 . . . intermediate layer (Ni layer)
80 . . . connecting member (solder)
80a . . . fillet
82 . . . substrate
84 . . . land

What is claimed is:

1. An electronic component comprising:
a wire; and
a terminal electrode connected to a lead of the wire and at least partly covered with a deposited film,
wherein
the deposited film of the terminal electrode connected to the lead comprises a surface having a glossy surface with fewer surface irregularities than those of a non-glossy surface remaining as-is as of formation of the deposited film, and
the glossy surface is located near the lead connected to the terminal electrode.

2. The electronic component according to claim 1, wherein the glossy surface is provided on a surface of the terminal electrode for a predetermined distance along a longitudinal direction of the lead connected to the terminal electrode.

3. The electronic component according to claim 1, wherein the glossy surface is provided on a surface of the terminal electrode for at least a predetermined width from a centerline of the lead to both sides of the centerline.

4. The electronic component according to claim 1, wherein
the terminal electrode comprises
a connecting portion connected to the lead, and
an extending portion extending from the connecting portion,
the connecting portion comprises the glossy surface, and
the extending portion comprises the non-glossy surface.

5. The electronic component according to claim 4, wherein the extending portion is bent at a predetermined angle relative to the connecting portion.

6. The electronic component according to claim 4, wherein
the electronic component further comprises a core including a wound portion and a flange,
the wire is wound around the wound portion,
the extending portion of the terminal electrode is partly attached to a part of an outer surface of the core, and
the connecting portion is at least partly away by a predetermined distance from the outer surface of the core.

7. A coil device comprising:
a wire; and
a terminal electrode connected to a lead of the wire and at least partly covered with a deposited film,
wherein
the deposited film of the terminal electrode connected to the lead comprises a surface having a glossy surface with fewer surface irregularities than those of a non-glossy surface remaining as-is as of formation of the deposited film, and
the glossy surface is located near the lead connected to the terminal electrode.

8. A pulse transformer comprising the coil device according to claim 7.

9. A method of manufacturing an electronic component, comprising:
thermocompression bonding a lead of a wire to a surface of a terminal electrode; and
irradiating the surface near the lead bonded to the terminal electrode with an energy ray to smooth a surface of a deposited film on the surface of the terminal electrode for formation of a glossy surface near the lead.
